(19) United States
(12) Patent Application Publication
(10) Pub. No.: US 2017/0165779 A1
(43) Pub. Date: Jun. 15, 2017

(54) SMART HUB FOR A WELDING ELECTRODE FEEDER

(71) Applicant: Hobart Brothers Company, Troy, OH (US)

(72) Inventors: Steven Edward Barhorst, Sidney, OH (US); Christopher Hsu, Appleton, WI (US)

(21) Appl. No.: 14/968,452

(22) Filed: Dec. 14, 2015

(51) Int. Cl. B23K 9/12; B23K 9/10; B23K 9/133

(52) U.S. Cl. CPC B23K 9/125; B23K 9/133; B23K 9/1093

(57) ABSTRACT

A welding electrode feeder includes an electrode package support and control circuitry. The electrode package support is configured to be coupled to a package of electrode. The electrode package support includes a hub motor disposed within the electrode package support, wherein the hub motor is configured to rotate the package coupled to the electrode package support, and a sensor configured to sense one or more parameters of the electrode. The control circuitry is communicatively coupled to the hub motor, the sensor, and a downstream motor, and is configured to control the hub motor or the downstream motor based at least in part upon the one or more parameters of the electrode.

### BACKGROUND

The present disclosure relates generally to welders and, more particularly to an electrode wire package support for use in a welding wire feeder system.

A wide range of welding systems have been implemented for various purposes. In continuous welding operations, a weld bead is formed by feeding welding wire from a welding torch. Processes may include gas metal arc welding (GMAW), flux-cored arc welding (FCAW), gas tungsten arc welding (GTAW), plasma arc welding (PAW), laser, cladding, brazing, submerged arc welding (SAW), laser-GMAW hybrid, multi-wire GMAW, and so forth. Electrical power is applied to the welding wire and a circuit is completed through the workpiece to sustain an arc that melts the wire and the workpiece to form the desired weld.

Typically, feed motor draws welding wire from a package of welding wire (e.g., a spool, a coil, a drum, a box, a reel, etc.), unwinding the welding wire. The package may be located within the wire feeder, or located remotely from the wire feeder, with welding wire being pushed, pulled, or both from the package to the wire feeder. In some instances, a pull motor in the welding torch itself also pulls on the welding wire, feeding the welding wire to the welding torch as the welding wire is consumed in performing a welding operation. In yet other embodiments, the package of welding wire may be located within the welding torch.

Such systems may be subject to numerous drawbacks. The unexpected emptying of the package may cause burnback, cause the user to stop in the middle of a welding operation, or may negatively impact the quality of the weld in some other way. Systems may also be subject to wire slip and/or wire slack, which may also lead to burnback or otherwise undesirable wire feed rates. Additionally, inertia of the package may limit the wire feeder's dynamic response to desired feed speed inputs, both for increasing and decreasing feed speed. Existing systems also allow for improper filler metal or an improper package of wire being used. Other issues related to wire feed may include wire stubbing, wire shaving, bird nesting, wire flip, arc start and stop, deteriorated contact tip, liner or conduit, gooseneck, interconnection.

There is a need, therefore, for improved welding wire feeder systems that allow for smooth and predictable unspooling of welding wire from a welding wire package.

### BRIEF DESCRIPTION

In one embodiment, a welding electrode feeding device includes an electrode package support and control circuitry. The electrode package support is configured to be coupled to a package of electrode. The electrode package support includes a support motor disposed within the electrode package support. The support motor is configured to rotate the package coupled to the electrode package support, and a sensor configured to sense one or more parameters of the electrode. The control circuitry is communicatively coupled to the support motor, the sensor, and a downstream motor, and is configured to control the support motor, the downstream motor, or both, based at least in part upon the one or more parameters of the electrode.

In another embodiment, a welding electrode feeding device includes an electrode package support and control circuitry. The electrode package support is configured to be coupled to a package of electrode. The electrode package support includes a weight sensor. The support motor is disposed within the electrode package support and configured to rotate the package coupled to the electrode package support. The weight sensor is configured to sense a weight of the electrode package. The control circuitry is communicatively coupled to the weight sensor and a downstream motor, wherein the control circuitry is configured to control the downstream motorbased at least in part upon the sensed weight.

In a further embodiment, a welding electrode feeding device includes an electrode package support and control circuitry. The electrode package support is configured to be coupled to a package of electrode. The electrode package support includes a support motor and a proximity sensor. The support motor is disposed within the electrode package support and configured to rotate the package coupled to the electrode package support. The proximity sensor is configured to sense one or more features disposed on or within the package. The control circuitry is communicatively coupled to the support motor, the proximity sensor, and a downstream motor, wherein the control circuitry is configured to control the support motor, the downstream motor, or both based at least in part upon the one or more features.

### DRAWINGS

These and other features, aspects, and advantages of the present disclosure will become better understood when the following detailed description is read with reference to the accompanying drawings in which like characters represent like parts throughout the drawings, wherein:

FIG. 1 is an embodiment of a welding system including a power supply and a wire feeder in accordance with aspects of the present disclosure;

FIG. 2 is a detailed view of one embodiment of the wire feeder system shown in FIG. 1 in accordance with aspects of the present disclosure;

FIG. 3 is a section view of one embodiment of a “smart hub” and welding wire spool shown in FIG. 2 in accordance with aspects of the present disclosure;

FIG. 4 is one embodiment of a tachometer that may be used in the wire feeder system in accordance with aspects of the present disclosure;

FIG. 5 is one embodiment of the smart hub having an RFID or Near Field Communication (NFC) reader in accordance with aspects of the present disclosure;

FIG. 6 is one embodiment of the smart hub having a machine readable code reader in accordance with aspects of the present disclosure;

FIG. 7 is one embodiment of the smart hub having a proximity sensor in accordance with aspects of the present disclosure;

FIG. 8 is a simplified view of one embodiment of the wire feeder system in accordance with aspects of the present disclosure;

FIG. 9 is one embodiment of the smart hub having a motor in accordance with aspects of the present disclosure;

FIG. 10 is one embodiment of the wire feeder system having a fixture for welding lengths of wire together in accordance with aspects of the present disclosure; and

FIG. 11 shows multiple embodiments of unique pin shapes in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Typically, a welding wire feeder draws welding wire from a package of welding wire (e.g., a spool, a coil, a drum, a box, a reel, etc.) mounted to a package support (e.g., a hub). Though the welding wire package is often referred to hereinafter as a spool, it should be understood that the welding wire package may be a spool, a coil, a drum, a box, or any other type of welding wire package. A downstream motor (e.g., a feed motor in the wire feeder) draws welding electrode wire off of the spool, de-spooling the welding wire. In some instances, the downstream motor, or a second downstream motor may be disposed within the welding torch. For example, a pull motor in the welding torch may pull on the welding wire, feeding the welding wire to the welding torch as the welding wire is consumed in the performance of a welding operation. Accordingly, the downstream motor may be a feed motor in the wire feeder, a pull motor in the welding torch, or both. The spool may or may not be located within the wire feeder. In some embodiments, the spool may be located within the welding torch. These systems may be subject to numerous drawbacks. The unexpected emptying of the spool may cause burnback, cause the user to stop in the middle of a welding operation, or may negatively impact the quality of the weld in some other way. Wire slip and/or wire slack, may also lead to burnback or otherwise undesirable wire feed rates. Additionally, inertia of the spool may limit the wire feeder's dynamic response to desired feed speed inputs. For example, the torque required of the feed motor to start the spool rotating may limit wire feed speed acceleration. Similarly, the inertia of a rotating spool may result in continued wire feed when it is not desired. Existing systems also allow for improper filler metal or an improper spool of wire being used. Other issues related to wire feed may include wire stubbing, wire shaving, bird nesting, wire flip, arc start and stop, deteriorated contact tip, liner or conduit, gooseneck, interconnection.

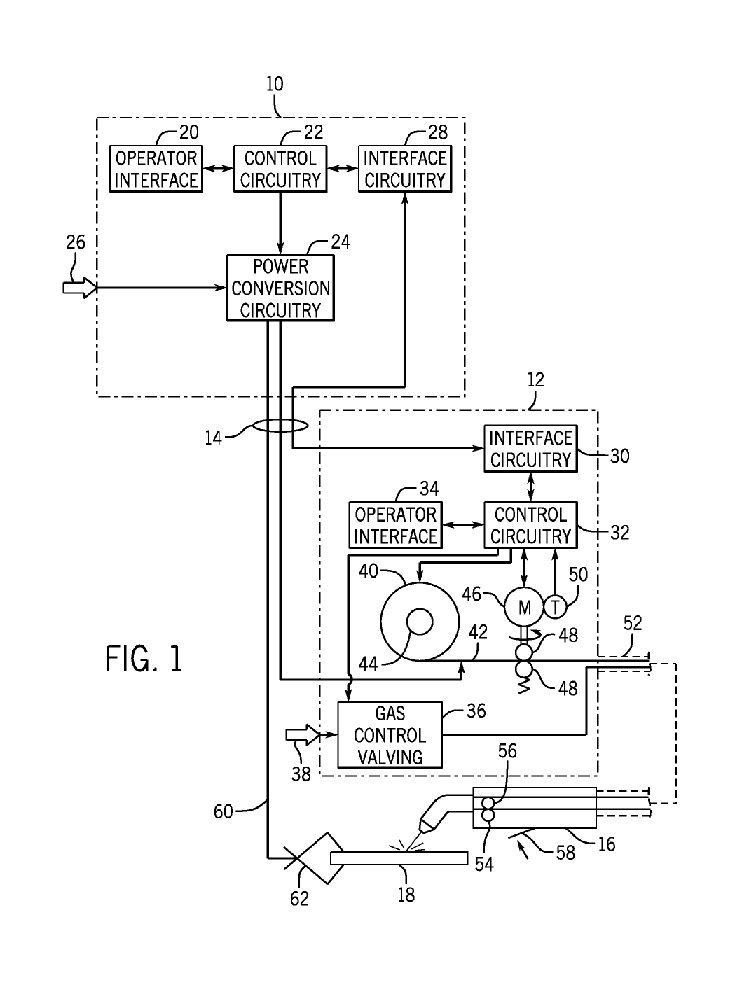

Turning now to the drawings, and referring first to FIG. 1, an embodiment of a welding system is illustrated as including a power supply 10 and a wire feeder 12 coupled to one another via conductors or conduits 14. In the illustrated embodiment the power supply 10 is separate from the wire feeder 12, such that the wire feeder may be positioned at some distance from the power supply near a welding location. However, it should be understood that the wire feeder 12, in some implementations, may be integral with the power supply 10. In such cases, the conduits 14 would be internal to the system. In embodiments in which the wire feeder 12 is separate from the power supply 10, terminals are typically provided on the power supply and on the wire feeder to allow the conductors or conduits 14 to be coupled to the systems so as to allow for power and gas to be provided to the wire feeder 12 from the power supply 10, and to allow data to be exchanged between the two devices.

The system is designed to provide wire, power, and shielding gas to a welding torch 16. As will be appreciated by those skilled in the art, the welding torch 16 may be of many different types, and typically allows for the feed of a welding wire and gas to a location adjacent to a workpiece 18 where a weld is to be formed to join two or more pieces of metal. A second conductor is typically run to the welding workpiece 18 so as to complete an electrical circuit between the power supply 10 and the workpiece 18.

The system is designed to allow for data settings to be selected by the operator, particularly via an operator interface 20 provided on the power supply 10. The operator interface 20 will typically be incorporated into a front faceplate of the power supply 10, and may allow for selection of settings such as the weld process, the type of wire to be used, voltage and current settings, and so forth. In some embodiments, the operator interface 20 may be used to provide user-perceptible warnings in certain circumstances (amount of wire on spool is low or below a threshold value, wire slip is detected, etc.) In particular, the system is designed to allow for welding with various steels, aluminums, or other welding wire that is channeled through the welding torch 16. These weld settings are communicated to control circuitry 22 within the power supply 10. The system may be particularly adapted to implement welding regimes designed for certain electrode types, such as tubular electrodes. The control circuitry 22 operates to control generation of welding power output that is applied to the welding wire for carrying out the desired welding operation.

The control circuitry is thus coupled to power conversion circuitry 24. This power conversion circuitry 24 is adapted to create the output power that will ultimately be applied to the welding wire at the torch. Various power conversion circuits may be employed, including choppers/buck converters, boost circuitry, inverters, converters, and so forth. The configuration of such circuitry may be of types generally known in the art in and of itself. The power conversion circuitry 24 is coupled to a source of electrical power as indicated by arrow 26. The power applied to the power conversion circuitry 24 may originate in the power grid, although other sources of power may also be used, such as power generated by an engine-driven generator, batteries, fuel cells or other alternative sources. Finally, the power supply 10 illustrated in FIG. 1 includes interface circuitry 28 designed to allow the control circuitry 22 to exchange signals with the wire feeder 12.

The wire feeder 12 includes complementary interface circuitry 30 that is coupled to the interface circuitry 28 of the power supply 10. In some embodiments, analog or digital interfaces may be provided on both components and a multi-conductor cable run between the interface circuitry to allow for such information as wire feed speeds, processes, selected currents, voltages or power levels, and so forth to be set on either the power supply 10, the wire feeder 12, or both.

The wire feeder 12 also includes control circuitry 32 coupled to the interface circuitry 30. As described more fully below, the control circuitry 32 allows for wire feed speeds to be controlled in accordance with operator selections, and permits these settings to be fed back to the power supply 10 via the interface circuitry 28, 30. The control circuitry 32 is coupled to an operator interface 34 on the wire feeder that allows selection of one or more welding parameters, particularly wire feed speed. The operator interface 34 may also allow for selection of such weld parameters as the process, the type of wire utilized, current, voltage or power settings, and so forth. In some embodiments, the operator interface 34 may be configured to allow the user to control one or more motors within the system to rotate a spool of welding wire forward or backward, to disengage the spool for diagnostic purposes, loading and/or unloading, and so forth. The control circuitry 32 is also coupled to gas control valving 36 which regulates the flow of shielding gas to the torch. In general, such gas is provided at the time of welding, and may be turned on immediately preceding the weld and for a short time following the weld. The gas applied to the gas control valving 36 is typically provided in the form of pressurized bottles, as represented by arrow 38.

The wire feeder 12 includes components for feeding wire to the welding torch and thereby to the welding application, under the control of control circuitry 32. For example, one or more spools of welding electrode wire 40 are housed in the wire feeder 12. Though the presently disclosed embodiments describe electrode wire, it should be understood that use of electrode shapes (e.g., strips) may be possible. Welding wire 42 is unspooled from the spools 40 and is progressively fed to the torch 16. The spool 40 is mounted on a spool support, or smart hub 44, which may have a number of features described later. A downstream motor (e.g., feed motor 46) is provided, which may include feed rollers 48, to push wire from the spool 40 toward the torch 16. The feed motor 46 may be an electric motor, a pneumatic motor, a hydraulic motor, or any other type of motor. One of the rollers 48 may be mechanically coupled to the motor 46 and is rotated by the motor 46, via a shaft, to drive the wire 42 from the spool 40, while the mating roller 48 is biased towards the wire to maintain good contact between the two rollers 48 and the wire 42. Some systems may include multiple rollers of this type. In some embodiments, the motor 46 and/or the rollers 48 may be disposed within the welding torch 16 rather than in a wire feeder 12. Finally, a tachometer 50 may be provided for detecting the speed of the shaft, the motor 46, the rollers 48, or any other associated component so as to provide an indication of the actual feed speed of the wire 42. Signals from the tachometer 50 are fed back to the control circuitry 32. In other embodiments, an encoder or resolver may be used in place of, or in addition to, the tachometer 50 to detect the speed of the shaft, the motor 46, the rollers 48, etc.

It should be noted that other system arrangements and input schemes may also be implemented. For example, the welding wire 42 may be fed from a bulk storage container (e.g., a drum) or from one or more spools outside of the wire feeder 12. Similarly, the wire may be fed from a “spool gun” in which the spool is mounted on or near the welding torch 16. Similarly, in some embodiments, the spool 40 and hub 44 may be disposed within the welding torch 16. As noted herein, the wire feed speed settings may be input via the operator interface 34 on the wire feeder 12 or on the operator interface 20 of the power supply 10, or both. In systems having wire feed speed adjustments on the welding torch 16, this may be the input used for the setting.

Power from the power supply 10 is applied to the wire 42, typically by means of a welding cable 52 in a conventional manner. Similarly, shielding gas is fed through the wire feeder 12 and the welding cable 52. During welding operations, the wire 42 is advanced through the welding cable jacket toward the torch 16. Within the torch, an additional pull motor 54 may be provided with an associated drive roller 56, particularly for aluminum alloy welding wires. The motor 54 is regulated to provide the desired wire feed speed. The tachometer 50, encoder, or resolver may be used to determine the actual wire feed speed. A trigger switch 58 on the torch 16 provides a signal that is fed back to the wire feeder 12 and therefrom back to the power supply 10 to enable the welding process to be started and stopped by the operator. That is, upon depression of the trigger switch 58, gas flow is begun, wire 42 is advanced, and power is applied to the welding cable 52 and through the torch 16 to the advancing welding wire 42. These processes are also described in greater detail below. Finally, a workpiece cable 60 and clamp 62 allow for closing an electrical circuit from the power supply 10 through the welding torch 16, the electrode (wire 42), and the workpiece 18 for maintaining the welding arc during operation.

It should be noted throughout the present discussion that while the wire feed speed may be “set” by the operator, the actual speed commanded by the control circuitry 32 will typically vary during welding for many reasons. For example, automated algorithms for “run in” (initial feed of wire for arc initiation) may use speeds derived from the set speed. Similarly, various ramped increases and decreases in wire feed speed may be commanded during welding. Other welding processes may call for “cratering” phases in which wire feed speed is altered to fill depressions following a weld. Still further, in pulsed welding regimes, the wire feed speed may be altered periodically or cyclically.

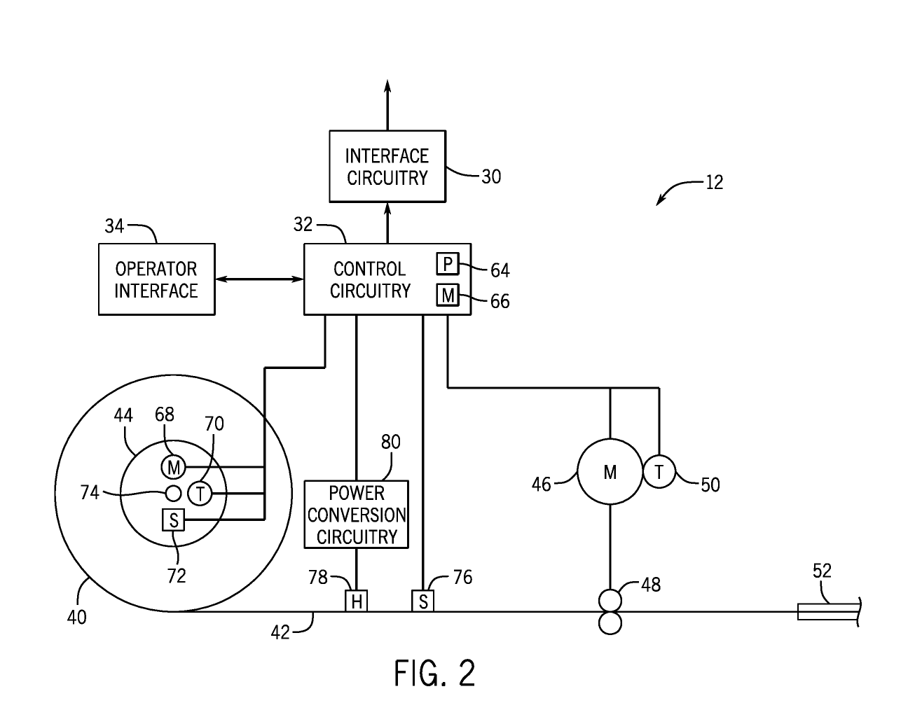

A more detailed view of one embodiment of the wire feeder system 12 shown FIG. 1 is shown in FIG. 2. The control circuitry 32 may include a processor 64 and memory 66. The memory 66 may be a tangible, non-transitory, computer-readable medium, and may include, for example, random-access memory, read-only memory, rewritable memory, hard drives, and the like. The memory 66 may be used to store data, programs, or other instructions for the processor 64. The processor 64 may execute programs stored in memory 66.

Spool 40 is mounted on smart hub 44. The smart hub 44 may include a support motor (hub motor 68), a hub tachometer 70 (or encoder/resolver), and one or more hub sensors 72. Though the system 12 is shown in a separate wire feeder unit, it should be understood that some or all of the components shown in the system 12 may be disposed within the welding torch 16. The hub motor 68 may be an electric motor, a pneumatic motor, a hydraulic motor, or any other type of motor. The hub motor 68 may be configured to rotate the smart hub 44 and/or the spool 40 in order to assist the motor 46 in spooling and de-spooling the welding wire 42. For example, the hub motor 68 may be utilized to rotate the spool 40 forward or backward in order to manage the slack in the welding wire 42. In some embodiments, the hub motor 68 may be configured to output a constant torque. The hub motor 68 may be intentionally undersized. The hub motor 86 may assist in maintaining a desired tension in the welding wire 42, prevent tangling of the welding wire 42, or even spool the welding wire 42 back onto the spool 40 to take up slack in the welding wire 42. The smart hub 44 may also include a hub tachometer 70, which may be included in, or separate from, the hub motor 68, and configured to sense the rotational speed of the smart hub 44, the spool 40, or both. The smart hub 44 may have one or more sensors 72. The one or more sensors 72 may be a tachometer, a proximity sensor, a thermometer, a weight sensor, a Hall Effect sensor, an encoder, a resolver, a torque sensor, a motor current sensor, bar code scanner, QR scanner, RFID reader, Near Field Communication (NFC) reader, contact sensor, accelerometer, laser wire gauging micrometer (to check wire diameter), XRF spectral analyzer (to check wire chemistry), a grayscale, time of flight (ToF) camera, a humidity sensor, or laser imaging to determine whether spool is precision wound or random wound, a colorimetric sensor for detecting copper flashing/coating quality or the presence of rust or oxide, a magnetic sensor with bridge measurement circuit to detect flux fill percent in the tubular electrode, and the like, or some combination thereof. Though sensor 72 is shown in FIG. 2 as being part of the Smart Hub 44, the sensor 72 may be mounted near the hub (e.g., inside the shaft or coupled to the hub housing). Smart hub 44 may be mounted on a pin 74, which holds the spool 40 and smart hub 44 assembly in place. The smart hub 44 may remain on the pin 74, and spools 40 switched in and out, or a given smart hub 44 may remain coupled to a given spool 40, and the spool 40 and smart hub 44 assembly switched out and replaced with a new spool 40 and smart hub 44 assembly when the spool 40 is empty.

The wire feeder 12 system may also include a wire sensor 76 used to sense certain characteristics of the wire. For example the wire sensor 76 may detect parameters indicative of movement or the speed of the welding wire 42 between the spool 40 and the feed rollers 48. The wire sensor 76 may also detect the presence of rust or oxidation on the welding wire 42, or other imperfections in the welding wire 42. Additionally, the wire sensor 76 may be used to detect the diameter of the welding wire 42, the temperature of the wire 42, wire shape (e.g., ovalness), wire surface condition, wire color, a measurement of carbon content in the welding wire 42, a measurement of ferrite content in the welding wire 42, material composition (via XRF), and/or the type of material. Though the wire sensor 76 is shown in FIG. 2 between the spool 40 and the feed rollers 48, the wire sensor 76 may be attached or integral to the spool 40 or smart hub 44, located between the spool 40 and the feed rollers 48, located after the feed rollers 48, or located elsewhere within the wire feeder 12.

The wire feeder 12 system may also include a heater 78. The heater 78 may be used to pre-heat the welding wire 42 before feeding it to the welding torch 16. The heater 78 may be used to pre-heat or otherwise precondition the welding wire 42 so the welding wire 42 reaches the welding torch 16 at a predictable temperature. The heater may be located within the wire feeder, as shown in FIG. 2, or within the welding torch 16. In some embodiments, the heater 78 may draw power from power conversion circuitry 80. In other embodiments the heater 78 may draw power from the power conversion circuitry 24 in the welding power supply 10. The heater may be integral to the smart hub 44 or external to the smart hub. A high temperature heater (e.g., 350-600 degrees Celsius) may be used to pre-heat wire for high deposition and/or high speed welding. A lower temperature heater 78 may be used to reduce or eliminate moisture in the wire. Preheating wire may increase deposition, substantially reduce heat input and distortion, and reduce moisture in the wire. For example, the heater 78 may be configured to heat the wire to above 40, above 50, above 60, above 70, above 80, above 90, above 100, above 110, or even above 120 degrees Celsius. In such embodiments, certain additional measures may be taken regarding the heated spool 40 and electrode wire 42. For example, the heated spool 40 may be disposed within a protective cage. A high temperature wire liner may also be used. Additionally, because pre-heating the electrode wire 42 may result in reduced stiffness, so support may be added to the wire delivery path to prevent buckling or bird nest.

In some embodiments, sensor 72 may be a weight sensor configured to sense a parameter indicative of the weight of the smart hub 44 and spool 40 assembly. If the weight of the smart hub 44 is known, and the weight of the spool 40 is known, then these weights may be subtracted from the weight sensed by the sensor in order to determine the amount of welding wire 42 on the spool. Note that in some embodiments, the sensor 72 may be used to detect the weight of welding wire 42 on the spool 40 at the time the spool 40 is loaded into the wire feeder 12, or upon startup of the wire feeder 12. The amount of wire 42 left on the spool 40 may then be derived by determining the amount of wire 42 used in the time since the spool 40 was loaded, and then debiting that amount from the amount of wire 42 on the spool 40 when the spool 40 was loaded. In other embodiments, the sensor 72 may be used to continuously measure the weight of the smart hub 44 and spool 40 assembly during operation such that at any moment the amount of wire 42 left on the spool 40 may be determined by subtracting the weight of the smart hub 44 and the spool 40 from the measured value. In other embodiments, the amount of wire 42 left on the spool 40 may be determined without use of a weight sensor 72.

In some embodiments, the control circuitry 32 may control the hub motor 68, the downstream motor (e.g., feed motor 46 and/or pull motor 54) using a variety of feedback loops (e.g., torque loop, speed loop, position loop, etc.). It should be understood that the control circuitry 32 may apply different feedback loops to the various motors 68, 46, 54 at a given moment. For example, the control circuitry 32 may control the feed motor 46 using a speed feedback loop and the hub motor 68 using a torque feedback loop. Alternatively, the control circuitry 32 may control the pull motor 54 using a position feedback loop and then use a wire buffer sensor (used to determine wire slack in the liner) as sensor 76 to check a specified length of wire fed off the spool 40. For example, when not welding, it may be possible to “reset” the amount of wire 42 by moving the hub motor 68 in either direction while the downstream motor 46 acts as a brake so that the desired about of wire 42 remains in the liner. This sill prepare the wire feeder 12 for the next arc start and avoid wire feeding inconsistency in the next arc start. In other embodiments, the control circuitry 32 may control the motors 68, 46, 54 according to a master-slave control scheme. In one embodiment, during arc start, the control circuitry 32 may start the hub motor 68 before the feed motor 46 in order to overcome the spool 40 inertia to ensure a smooth feed of electrode wire 42 to the workpiece 18, or otherwise synchronize the hub motor 68 and the downstream motors 46, 54. In other embodiments, the control circuitry 32 may run the hub motor 68 backward to act as a brake, or to take up excess wire in the liner in order to reduce or eliminate unpredictable wire feed upon the next arc start. These are only a few possible embodiments. It should be understood that other embodiments are possible.

In some embodiments, the control circuitry 32 may use readings from various sensors 50, 70, 72, 76 within the wire feeder 12 system, determine various metrics, and then pass those metrics on to interface circuitry 30 for communication to the rest of the welding system. The metrics may include the wire type, the chemical makeup of the wire, wire diameter, wire feed rates, and the like. Disclosures and more detailed descriptions of exemplary data collection, processing, analysis and presentation techniques (such as those used in the Miller Electric Insight platform) are set forth in U.S. patent application Ser. No. 13/837,976 entitled “WELDING RESOURCE PERFORMANCE GOAL SYSTEM AND METHOD,” filed on Mar. 15, 2013, U.S. patent application Ser. No. 13/838,860 entitled “WELDING RESOURCE TRACKING AND ANALYSIS SYSTEM AND METHOD,” filed on Mar. 15, 2014, U.S. patent application Ser. No. 13/838,541 entitled “WELDING RESOURCE PERFORMANCE COMPARISON SYSTEM AND METHOD,” filed on Mar. 15, 2013, U.S. patent application Ser. No. 14/316,219 entitled “WELDING SYSTEM PARAMETER COMPARISON SYSTEM AND METHOD,” filed on Jun. 26, 2014, U.S. patent application Ser. No. 14/316,250 entitled “WELDING SYSTEM DATA MANAGEMENT SYSTEM AND METHOD,” filed on Jun. 26, 2014, and U.S. patent application Ser. No. 14/553,713 entitled “SYSTEM FOR ESTIMATING THE AMOUNT AND CONTENT OF FUMES,” filed on Nov. 25, 2014, which are hereby incorporated into the present disclosure by reference in their entireties.

In some embodiments, the control circuitry 32 may also be used to run diagnostics on the wire feeder when it is determined that one or more components are not operating properly. For example, the control circuitry 32 may instruct the hub motor 68, and the feed motor 46 and/or the pull motor 54 to advance the electrode wire 42 a short distance (e.g., less than a few inches) to check for excessive torque, which may indicate a feeding issue (e.g., a dirty liner from copper flaking, wire shaving from drive rolls, burn-back from a previous weld, worn liner or tip, wire tangle, clogged liner, oversized tip, etc.). In some embodiments, clutches may be used to selectively disengage one or more motors 68, 46, 54 in order to diagnose a problem. These techniques may be used to isolate the motors 68, 46, 54, compare torque to what may be expected, and identify a location or zone within the wire feeder 12 in which the problem may be occurring, which may shorten the amount of time that a welding system is offline to repair the problem.

As previously discussed regarding FIG. 1, the wire feeder 12 includes a motor 46, and may also include a tachometer 50 and one or more feed rollers 48 to assist in de-spooling the welding wire 42 from the spool 40 and into the welding cable 52.

One feature of the smart hub 44 is the ability to determine the amount of wire 42 left on the spool 40. This may be done in a number of different ways. Some of the dimensions used to determine the amount of wire 42 left on the spool 40 are shown in FIG. 3. FIG. 3 is a section view of an embodiment of the smart hub 44 coupled to a spool 40 wound with wire 42. The smart hub 44 has a radius of 82. The spool 40 has a radius 84, which is half of the outside diameter of the spool 40. Welding wire 42, having wire diameter 86 may be precision would around the spool 40 such that the thickness of wire wrapped around the spool 90 may be determined by subtracting the spool radius 84 from the wound wire radius 88. The number of layers of wire wrapped around the spool may be determined by dividing the wound wire thickness 90 by the wire diameter 86. If the width of the spool 40 is known, the approximate length of wire 42 on the spool 40 may be determined.

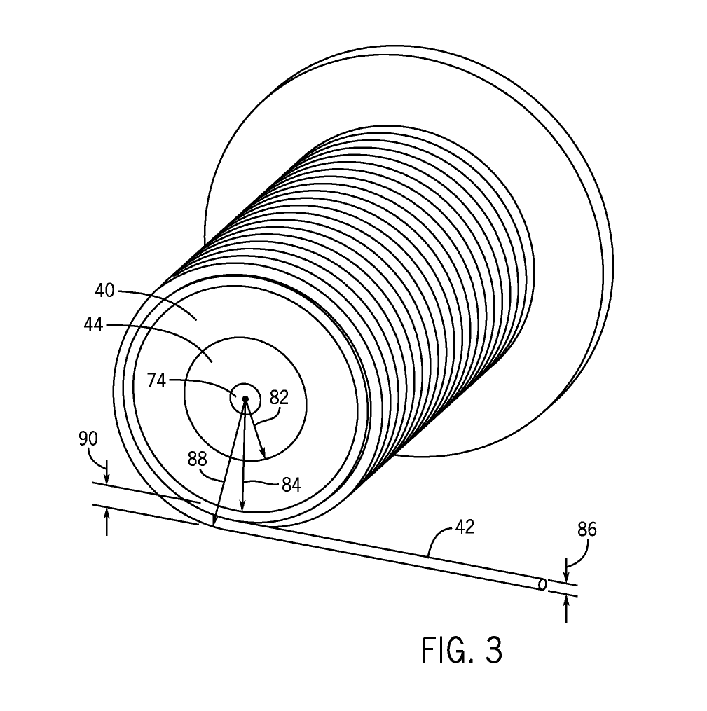

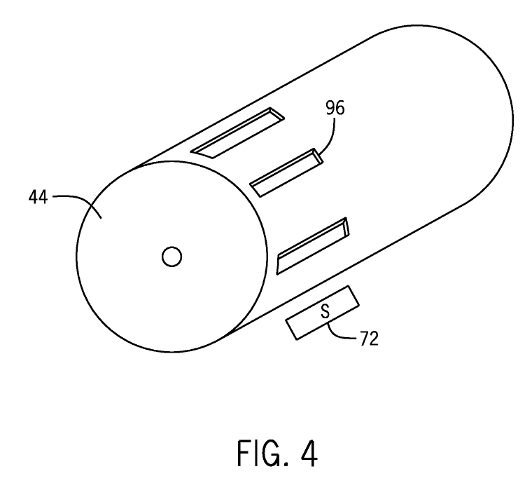

FIG. 4 shows one embodiment of a tachometer 50, 70 or other sensor to detect rotation that may be used in any of the rotating components described. In one embodiment, smart hub 44 includes one or more recesses 96, marks, indentations, stickers, etc. on the exterior or interior of the smart hub 44. A sensor 72 then detects each time a recess goes by. Sensor 72 may be an encoder, a Hall Effect sensor, an optical sensor, or some other kind of sensor. When the number of recesses 96 or other marks on the rotating component are known, the angular velocity of the rotating component may be determined. Knowing the angular velocity of a rotating component may help determine many other characteristics of the wire feeder system 12, including the amount of wire 42 left on the spool 40, slippage, slack, wire 42 feed rate, the amount of wire 42 used, etc.

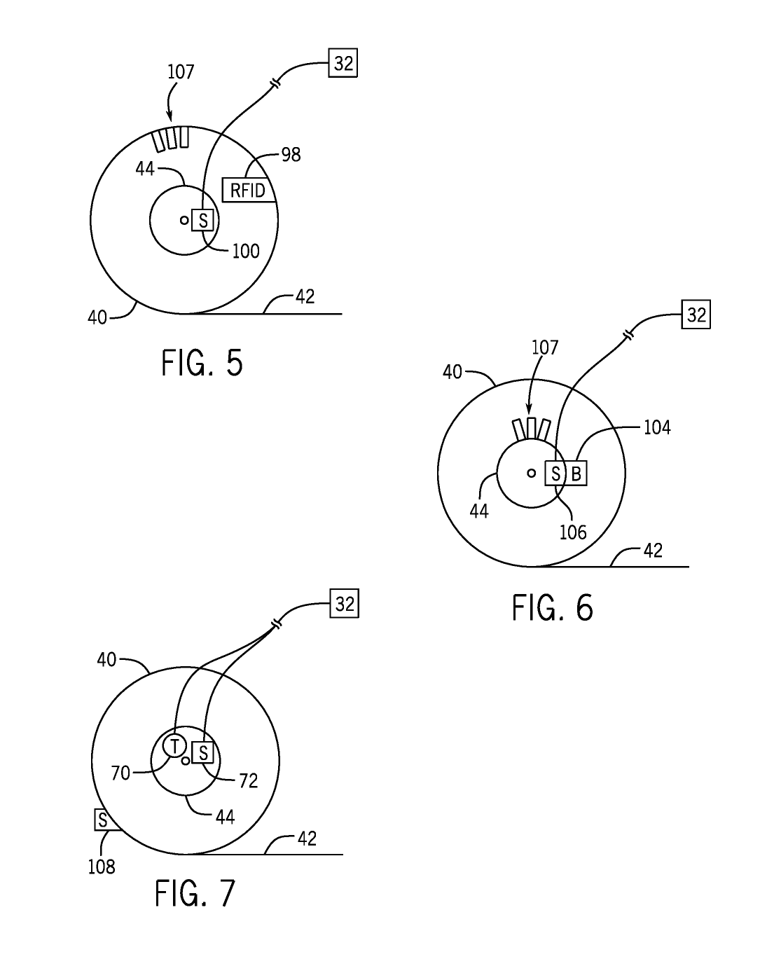

FIG. 5 shows an embodiment of the smart hub 44 and spool 40 using Near Field Communication (NFC), RFID, or proximity sensor to transmit information about the wire 42. In one embodiment, the smart hub 44 may include an NFC reader, proximity sensor, or RFID reader 100 communicatively coupled to the wire feeder control circuitry 32. The reader 100 may be of the type described with regard to FIGS. 2 and 4, or may be of some other type. The spool 40 may be equipped with an RFID or NFC tag 98 on or molded into the spool 40, which contains information about the wire 42 on the spool 40. For example, a 1-5 mm operating range may be used with an NFC tag 98 and reader 100 in order to avoid confusion with other nearby spools 40. If an RFID tag 98 is used, it may be ISO 15683 compliant. In some embodiments, the tag 98 may be a passive tag, which draws power from the energy in a radio wave from the reader 100 rather than a dedicated power source. The tag 98 may include information concerning the length of wire 42 on the spool 40, the weight of wire 42 on the spool 40, the diameter of the wire 42 on the spool 40, the type or composition of wire 42 on the spool 40, the heat number (for steel chemistry certification traceability or other uses), compatible shielding gas blends, compatible polarities, compatible welding position, compatible welding processes, suitable wire feed speed ranges, health and safety data, a quality control record, code compliance (e.g., B21 or ASME), wire manufacturing traceability information, etc. The reader 100 may be incorporated into the smart hub 44 and capable of reading the information from the tag 98. In some embodiments, the control circuitry may use the information read by the reader 100 to check and/or confirm the compatibility of the wire, gas, polarity, feed rate, weld process, and the like. Using the information read from the tag 98, a number of metrics may be tracked. For example, if the RFID or NFC tag 98 contains information about the length of wire 42 on the spool 40, the length of wire used (determined based on feed rate) may be debited from the full length to determine the length of wire 42 left on the spool 40. If the RFID or NFC tag 98 contains the diameter of the wire, and the wound wire thickness 90 is known, then the approximate length of wire 42 left on the spool 40 may be determined. If the RFID or NFC tag 98 conveys the type of wire 42 being used, the spool 40 may use this in conjunction with the diameter of the wire 42 and the feed rate to determine metrics for the user such regarding the fumes generated and the like. It should be understood, however, that the examples described above are merely examples and not intended to limit the possible embodiments. An RFID or NFC tag 98 may be used to convey many different types of information regarding the welding wire 42, the spool 40, or other parts of the welding system to the smart hub 44.

Alternatively, similar techniques may be used to encode information on the spool packaging. For example, as shown in FIGS. 5 and 6, a sensor 100 (e.g. an inductive non-contact proximity sensor) may detect features 107 (e.g., notches, spot welds, pre-notched strips, etc.) in the inner or outer rim of the spool 40. These reading may remain in time-scale as read, or converted to distance scale based on the rotational speed of the hub 44 sensed by the tachometer 70. The readings may decoded into filler metal identification code and then be compared to the weld procedure specification to ensure compatibility with the weld procedure.

Similarly, an embodiment that uses a barcode 104 to convey information to the smart hub 44 is shown in FIG. 6. In the embodiment shown in FIG. 6, the barcode 104 and barcode reader 106, which is communicatively coupled to the control circuitry 32, are arranged such that the barcode reader 106 faces outward from the outside surface of the smart hub 44 and the barcode 104 is disposed on the interior surface of the spool 40 and faces inward such that when the spool 40 is mounted on the smart hub 44, the barcode reader 106 may read the barcode 104. The barcode 104 may be typical in shape (i.e., rectangular in shape), or printed, engraved, attached, or otherwise disposed circumferentially around the interior of the spool 40 such that the barcode 104 may be read when the smart hub 44 is spinning regardless of how the spool 40 is mounted to the smart hub 44. It should be understood that barcode 104 may be a traditional barcode, a QR code, or any other machine readable code disposed on or within the spool 40. As with the RFID or NFC tag 98 discussed in regard to FIG. 5, the barcode 104 may be used to convey information concerning the amount of wire 42 on a full spool 40, the weight of wire 42 on a full spool 40, the diameter of the wire 42 on the spool 40, the type or composition of wire 42 on the spool 40, the heat number (for steel chemistry certification traceability or other uses), compatible shielding gas blends, compatible polarity, compatible weld position, compatible welding processes, suitable wire feed speed ranges, and the like. Information read from the barcode 104 may be used, in conjunction with measurements taken or information from other sensors in the system to determine how much welding wire 42 is left on the spool 40, how much welding wire 42 has been used, whether slippage is occurring, whether there is slack, fumes being generated, etc. In other embodiments, the sensor 106 may be a contact sensor (e.g., resistance or impedance sensor) and memory device reader. For example, the hub 44 may have electrodes that make contact with mating electrodes on the interior of the spool 40. A resistor or other non-volatile memory device may be used to identify the wire 42, or some other quality or qualities of the spool 40.

FIG. 7 shows an embodiment of the smart hub 44 that uses a proximity sensor 108 to determine the amount of wire 42 on the spool 40. Sensor 108 may be used to sense how far away from the sensor 108 the spooled wire 42 is. If the position of the proximity sensor 108 is known, the outside diameter of the wound wire (or the wound wire radius 88) may be determined from the measurement taken from the proximity sensor 108. If the spool radius 84 is known, then the wound wire thickness 90, and thus the amount of wire 42 left on the spool 40, may be determined. Proximity sensor 108 may be a magnetic sensor (if the welding wire is ferromagnetic), an optical sensor, a contact sensor (e.g., a moveable arm that remains in contact with the wound wire as it unspools, the would wire radius 88 determinable based upon the angle of the arm), or some other kind of sensor capable of measuring qualities indicative of the wound wire radius 88.

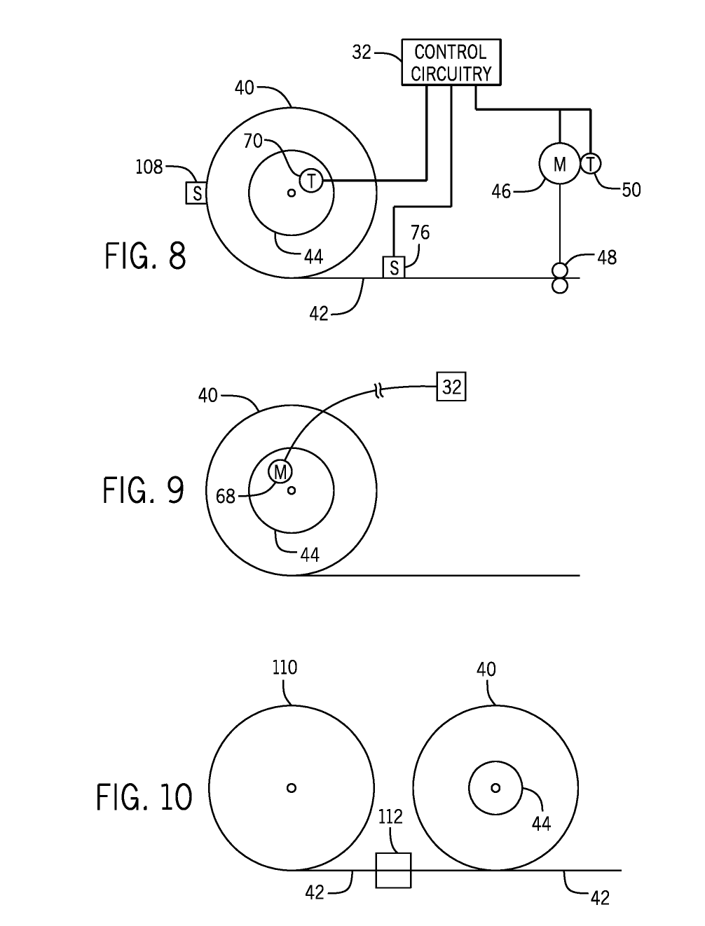

FIG. 8 shows a simplified view of the wire feeder system 12 shown in FIG. 2. Though some components shown in FIG. 2 are not shown in FIG. 8 (e.g., heater 78, motor 68, tachometer 70), it should be understood that this is for the sake of clarity, and those elements not shown in FIG. 8 may be present in some embodiments of the wire feeder system 12. The embodiment of the wire feeder system 12 shown in FIG. 8 includes a variety of ways to determine the feed rate of the welding wire 42 at different locations. By comparing the wire 42 feed rates at more than one location within the wire feeder 12 (i.e., at least one “upstream” location and one “downstream” location), or motor torque and/or feeding force, the presence of wire slippage or wire slack may be determined. For example, the proximity sensor 108 and the hub tachometer 70 may be used to determine the feed rate of welding wire 42 off the spool 40. Sensor 76 may be used to determine the feed rate between the spool 40 and the drive motor 46. The tachometer 50 and the feed roller 48 radius may be used to determine the wire 42 feed rate at the drive motor 46. If one of the measured feed rates downstream (i.e., at the feed motor 46 or the wire sensor 76) is higher than a measured feed rate upstream (i.e., at spool 40 or wire sensor 76), this may be indicative of wire slip. If, on the other hand, one of the measured feed rates downstream (i.e., at the feed motor 46 or the wire sensor 76) is lower than a measured feed rate upstream (i.e., at spool 40 or wire sensor 76), this may be indicative of wire slack in the system. Similar determinations of wire slip and/or slack may be made based on motor torque or feeding force. Thus, by determining the welding wire 42 feed rate at one location, and then comparing that feed rate to the feed rate at another point upstream or downstream, the system may determine whether wire slippage or wire slack is present in the system and accordingly adjust the settings of the system, send notifications to other components within the system, turn off one or more components within the system to remedy the problem, or alert the user (e.g., user-perceptible warning).

FIG. 9 shows an embodiment of smart hub 44 having a motor 68 that may assist in spooling and de-spooling the welding wire 42 from the spool 40. Typically, one or more motors (e.g., feed motor 46, pull motor 54, etc.) are used downstream from the spool 40 to draw welding wire 42 from the spool. The hub/spool assembly may use a clutch or braking mechanism to control rotation of the spool 40. However, in the smart hub 44 embodiment shown in FIG. 9, a motor 68 in communication with control circuitry 32 is used to assist in spooling and de-spooling welding wire in order to prevent, slippage, slack, tangling, etc. The motor 68 may be capable of rotating the spool 40 clockwise or counterclockwise. In some embodiments, the motor 68 may be capable of applying a torque in order to maintain a desired tension on the welding wire 42 so as to avoid slack, slippage, tangling, and the like. Additionally, the control circuitry 32 may be capable of determining the amount of wire 42 left on the spool 40 by measuring the startup torque applied in order to get the spool 40 to begin rolling. Similarly, the control circuitry 32, may be capable of determining the amount of welding wire 42 left on the spool 40 based upon the startup torque of the feed motor 46.

FIG. 10 shows an embodiment in which butt welding is used to attach the end of one length of wire wrapped around the spool 40 to the beginning of another length of wire wrapped around a reserve spool 110, resulting in “endless” welding wire 42. In one embodiment, the end of the length welding wire wound around the spool 40 is butt welded to the beginning of the length of welding wire 42 wound around a reserve spool 110 using a butt welding fixture 112. In this embodiment the end of the length of welding wire 42 wrapped around spool 40 is placed in a butt welding fixture 112 with the beginning the length of welding wire wrapped around reserve spool 110. Once the two ends are welded together, the excess material is filed off. The two lengths of welding wire wrapped around the spool 40 and reserve spool 110 is then a single, continuous piece of welding wire 42 that may be fed through the wire feeder 12 without having to stop and replace the spool 40. This process may be repeated any number of times such that the supply of welding wire is seemingly “endless.”

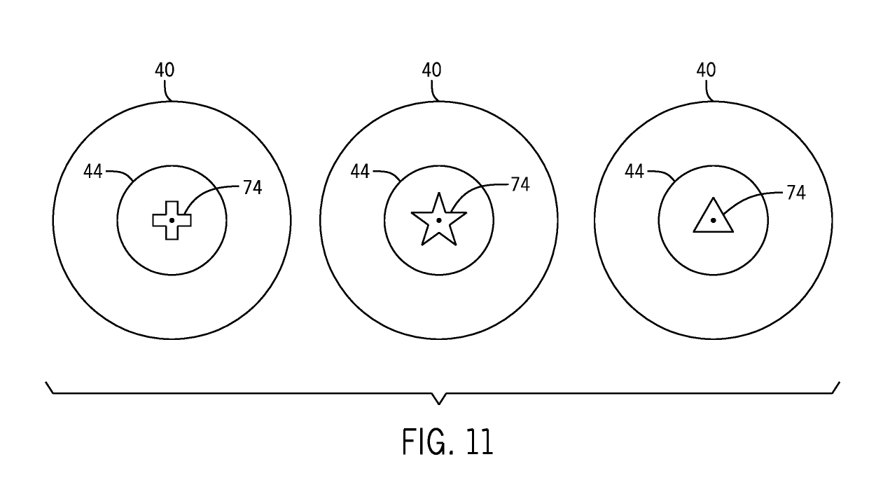

FIG. 11 shows multiple embodiments of pins having different shapes, which may be used to prevent users from installing a spool 40 of incorrect wire 42 into the wire feeder 12. For example, a given welding facility may use three different kinds of welding wire 42. The facility may configure the pins 72, smart hubs 44 and spools 40 such that a spool/hub assembly loaded with one type of wire may only be loaded into a wire feeder 12 configured to use that kind of wire. As shown in FIG. 11 the pins may be shaped like the letter X, a star, a triangle, or any other number of shapes, as long as the wrong type of wire may not be loaded into the wrong wire feeder 12.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A welding electrode feeding device comprising:
an electrode package support configured to be coupled to a package of an electrode, the electrode package support comprising:
a support motor disposed within the electrode package support, wherein the support motor is configured to rotate the package coupled to the electrode package support; and
a sensor configured to sense one or more parameters of the electrode; and
control circuitry communicatively coupled to the support motor, the sensor, and a downstream motor, wherein the control circuitry is configured to control the support motor, the downstream motor, or both, based at least in part upon the one or more parameters of the electrode.

2. The welding electrode feeding device of claim 1, wherein the package comprises a spool, a coil, a drum, a box, a reel, or a combination thereof.

3. The welding electrode feeding device of claim 1, wherein the downstream motor is disposed within the welding electrode feeding device.

4. The welding electrode feeding device of claim 1, wherein the downstream motor is disposed within a welding torch.

5. The welding electrode feeding device of claim 1, wherein the sensor is configured to sense parameters indicative of rust or oxidation, a diameter of the electrode, a material composition, a shape of the electrode, a surface condition of the electrode, a color of the electrode, a measurement of carbon content in the electrode, a measurement of ferrite content in the electrode, or a combination thereof.

6. The welding electrode feeding device of claim 1, wherein the electrode package support comprises a machine readable code reader configured to read machine readable code disposed on or within the package.

7. The welding electrode feeding device of claim 6, wherein the machine readable code contains information relating to a type of the electrode, a diameter of the electrode, a length of the electrode in the package, a heat number, compatible shielding gas blends, compatible polarities, compatible welding positions, compatible welding processes, suitable welding processes, health and safety data, quality control data, code compliance data, electrode manufacturing traceability information, or a combination thereof.

8. The welding electrode feeding device of claim 7, wherein the control circuitry is configured to use information from the machine readable code to confirm compatibility of the electrode, a gas, a polarity, a feed rate, a welding process, a selected welding program, or a combination thereof.

9. The welding electrode feeding device of claim 6, wherein the electrode package support comprises an RFID reader configured to read an RFID tag coupled to the package or a near field communication (NFC) reader configured to read an NFC tag coupled to the package.

10. The welding electrode feeding device of claim 1, the electrode package support comprising a unique engagement pin, wherein the unique engagement pin corresponds to a type and size of electrode such that a user may load a desired package of desired electrode size and type.

11. The welding electrode feeding device of claim 1, wherein the sensor is configured to sense a weight of the package.

12. The welding electrode feeding device of claim 1, wherein the control circuitry is configured to determine a weight of the electrode in the package based at least in part upon a torque required of the support motor to rotate the package.

13. The welding electrode feeding device of claim 1, wherein the control circuitry is configured to shut down the welding electrode feeding device, to generate a notification to communicate to one or more components, or to create a user-perceptible warning when a first electrode feed rate measured at a first location within the welding electrode feeding device is substantially greater than or substantially less than a second electrode feed rate at a second location upstream or downstream of the first location, or when an excessive torque of the support motor or feeding force of the support motor is detected.

14. The welding electrode feeding device of claim 1, wherein the control circuitry is configured to turn off the welding electrode feeding device, to generate a notification to communicate to one or more components, or to create a user-perceptible warning when an amount of the electrode in the package is below a threshold value.

15. The welding electrode feeding device of claim 1, wherein the control circuitry is configured to communicate to an operator interface a type of the electrode, a diameter of the electrode, an amount of the electrode, a feed rate of the electrode, or a combination thereof.

16. The welding electrode feeding device of claim 1, wherein the control circuitry is configured to apply a torque feedback loop, a speed feedback loop, a position feedback loop, or a combination thereof, to the support motor, a feed motor, a pull motor in a welding torch, or a combination thereof, in order to optimize feeding of the electrode.

17. The welding electrode feeding device of claim 1, wherein the control circuitry is configured to control the support motor and the downstream motor with a master-slave control scheme.

18. The welding electrode feeding device of claim 1, wherein the control circuitry is configured to synchronize the support motor and the downstream motor for arc start upon depression of a trigger on a welding torch.

19. The welding electrode feeding device of claim 1, wherein the control circuitry is configured to run diagnostics in order to diagnose a problem within the welding electrode feeding device, or to identify a location of the problem within the welding electrode feeding device.

20. The welding electrode feeding device of claim 1, comprising a heater configured to condition the electrode.

21. The welding electrode feeding device of claim 20, wherein the heater is configured to preheat the electrode to a temperature above 40 degrees Celsius.

22. The welding electrode feeding device of claim 1, comprising a fixture configured to hold an end of a first length of electrode and an end of a second length of electrode such that the first length of electrode and the second length of electrode may be welded together such that the welding electrode feeding device may continuously feed the first length of electrode and the second length of electrode.

23. The welding electrode feeding device of claim 1, wherein the welding electrode feeding device is disposed within a welding wire feeder.

24. The welding electrode feeding device of claim 1, wherein the welding electrode feeding device is disposed within a welding torch.

25. A welding electrode feeding device comprising:
an electrode package support configured to be coupled to a package of an electrode, the electrode package support comprising a weight sensor configured to sense a weight of the package; and
control circuitry communicatively coupled to the weight sensor, wherein the control circuitry is configured to control a motor driving rotation of the electrode package support based at least in part upon the sensed weight.

26. The welding electrode feeding device of claim 25, comprising a support motor disposed within the electrode package support and configured to rotate the package coupled to the electrode package support, wherein the support motor is communicatively coupled to the control circuitry, and wherein the control circuitry is configured to control the support motor, a downstream motor, or both, based at least in part upon the sensed weight.

27. The welding electrode feeding device of claim 26, wherein the control circuitry is configured to subtract a weight of an empty electrode package to determine an amount of electrode in the package.

28. The welding electrode feeding device of claim 26, wherein the control circuitry is configured to shut down the welding electrode feeding device, to generate a notification to communicate to one or more components, or to create a user-perceptible warning when a first electrode feed rate measured at a first location within the welding electrode feeding device is substantially greater than or substantially less than a second electrode feed rate at a second location upstream or downstream of the first location.

29. The welding electrode feeding device of claim 26, wherein the electrode package support comprises an RFID reader configured to read an RFID tag coupled to the package or a near field communication (NFC) reader configured to read an NFC tag coupled to the package.

30. The welding electrode feeding device of claim 26, wherein the electrode package support comprises a machine readable code reader configured to read machine readable code disposed on a surface of the package.

31. The welding electrode feeding device of claim 30, wherein the machine readable code contains information relating to a type of the electrode, a diameter of the electrode, a heat number, compatible shielding gas blends, compatible polarities, compatible welding positions, compatible welding processes, suitable welding parameters, health and safety data, quality control data, code compliance data, electrode manufacturing traceability information, or a combination thereof.

32. The welding electrode feeding device of claim 26, comprising a heater configured to condition the electrode.

33. A welding electrode feeding device comprising:
an electrode package support configured to be coupled to a package of an electrode, the electrode package support comprising:
a support motor disposed within the electrode package support and configured to rotate the package coupled to the electrode package support; and
a proximity sensor configured to sense one or more features disposed on or within the package; and
control circuitry communicatively coupled to the support motor, the proximity sensor, and a downstream motor, wherein the control circuitry is configured to control the support motor, the downstream motor, or both, based at least in part upon the one or more features.

34. The welding electrode feeding device of claim 33, wherein the one or more features disposed on or within the package comprise notches, spot welds, or pre-notched strips.

35. The welding electrode feeding device of claim 34, wherein the one or more features are disposed on a surface of the package.

36. The welding electrode feeding device of claim 33, wherein the one or more features disposed on or within the package are configured to communicate encoded data.

37. The welding electrode feeding device of claim 36, wherein the encoded data contains information relating to a type of the electrode, a diameter of the electrode, a length of the electrode in the package, a heat number, compatible shielding gas blends, compatible polarities, compatible welding positions, compatible welding processes, suitable welding parameters, health and safety data, quality control data, code compliance data, electrode manufacturing traceability information, or some combination thereof.
